(19) United States
(12) Patent Application Publication
(10) Pub. No.: US 2008/0252089 A1
(43) Pub. Date: Oct. 16, 2008

(54) MOUNTING DEVICE FOR FIXING A PORTABLE ELECTRONIC DEVICE

(76) Inventor: Andreas Hecht, Chicago, IL (US)

Correspondence Address: QUARLES & BRADY LLP, 411 E. WISCONSIN AVENUE, SUITE 2040, MILWAUKEE, WI, 53202-4497, US

(21) Appl. No.: 12/100,475

(22) Filed: Apr. 10, 2008

(30) Foreign Application Priority Data
Apr. 11, 2007 (DE) 20 2007 005 311.8

(51) Int. Cl. B60R 11/02

(52) U.S. Cl. 296/1.07

(57) ABSTRACT

The invention pertains to a mounting device for fixing a portable electronic device, particularly a portable navigation system, in the interior of a vehicle. The mounting device includes a mounting element that can be detachably fixed on a component of the vehicle and a device carrier, on which the electronic device can be detachably fixed. The mounting element and the device carrier connected to one another by a connecting element, the length of which is adjustable between at least two positions.

### CROSS REFERENCE TO RELATED APPLICATION

This application claims the priority benefit of German Utility Model Application No. 20 2007 005 311.8 filed Apr. 11, 2007, the contents of which are hereby incorporated by reference as if set forth in its entirety herein.

### STATEMENT REGARDING FEDERALLY SPONSORED RESEARCH OR DEVELOPMENT

None.

### FIELD OF THE INVENTION

The invention pertains to a mounting device for fixing a portable electronic device, particularly a portable navigation system, in the interior of a vehicle.

### BACKGROUND OF THE INVENTION

Mounting devices of the generic type are used for fixing portable electronic devices, such as cellular phones or portable navigation systems, in the interior of a vehicle. To this end, the mounting devices are equipped with a mounting element that is suitable for fixing the mounting device in the interior of the vehicle. In addition, the mounting devices respectively feature a device carrier for accommodating the respective device to be fixed. A connecting element is also provided between the mounting element to be fixed on the vehicle and the device carrier that carries the electronic device such that the mounting device protrudes into the interior of the vehicle from the mounting point in the vehicle and thusly makes it possible for the user to operate the electronic device.

In certain mounting devices known from the state of the art, a connecting element in the form of a swan-neck is provided. These mounting devices have the disadvantage that the length of the connecting element is invariable such that the distance between the mounting point in the vehicle defined by the mounting element and the device carrier cannot be varied. This is particularly disadvantageous because the arrangement of the electronic device in the interior of the vehicle therefore can only be varied to a very limited degree.

### SUMMARY OF THE INVENTION

The present invention provides a mounting device that allows for variable arrangement of the electronic device in the vehicle.

An embodiment of the present invention provides a mounting device for fixing a portable electronic device, particularly a portable navigation system, in the interior of a vehicle. The mounting device can include a mounting element that can be detachably fixed on a component of the vehicle, a device carrier, on which the electronic device can be detachably fixed, and a connecting element connecting the mounting element to the device carrier. The length of the connecting element can be adjustable between at least two positions. The length of the connecting element can be progressively adjustable between two end positions. A fixing device or a snap-in device can be provided on the connecting element in order to fix the connecting element in at least one end position and/or in at least one intermediate position between the two end positions. The connecting element can be configured to be self-locking in order to be fixed in the end positions and/or in intermediate positions. The connecting element can include a telescopic mechanism including a plurality of telescoping elements that are lengthwise telescopable. The connecting element can include a scissor jack mechanism including a plurality of scissor jack elements that are lengthwise adjustable. The mounting element can include a suction head that can be mounted on the vehicle, particularly on the windshield, by building up a negative pressure. The device carrier can be connected to the connecting element in a detachable and exchangeable fashion.

The mounting device can also include a uniaxially or multiaxially adjustable articulation provided between the mounting element and the connecting element. The mounting element can be realized symmetric about an axis of symmetry, particularly point-symmetric about a point of symmetry. The articulation can be arranged on the mounting element outside the axis of symmetry or outside the point of symmetry.

The mounting device can also include a multiaxially adjustable articulation provided between the device carrier and the connecting element, wherein the device carrier is connected to the articulation, in particular, in a detachable and exchangeable fashion. The device carrier can realized symmetric about an axis of symmetry, particularly point-symmetric about a point of symmetry, wherein the articulation is arranged on the device carrier outside the axis of symmetry or outside the point of symmetry. The articulation can be fixed by means of a fixing device or can be realized in a self-locking fashion.

An embodiment of the present invention can be based on the fundamental idea of realizing the connecting element such that its length can be adjusted between at least two positions. This lengthwise adjustability can make it possible to vary the spacing between the device carrier and the mounting element. This can enables the users, for example, to pull the device toward themselves together with the device carrier in order to realize a manual input on the display of the device, wherein this aspect can significantly improve the inputting convenience. After the input is completed, the device carrier can be pushed back in the direction of the mounting point such that the mounting device only protrudes into the interior by a short distance. The lengthwise adjustability of the connecting element can also provide significant advantages with respect to the stowage of the mounting device because the stowage volume can be significantly reduced due to the lengthwise adjustability.

According to one embodiment, the length of the connecting element can be progressively adjustable between two end positions that are defined, for example, by limit stops. This progressive adjustability can make it possible to exactly position the device in the manner desired by the user in the respective situation.

In order to prevent an unintentional adjustment of the mounting device after arranging the device carrier in a certain position, a fixing device or a snap-in device may be provided on the connecting element as proposed in a first embodiment. After positioning the device carrier, this position can be secured by fixing the fixing device or by engaging the snap-in device such that the mounting device subsequently can only be readjusted by exerting a specific adjusting force or by loosening the fixing device.

As an alternative to the utilization of a fixing device or a snap-in device, the connecting element may also be realized in a self-locking fashion in order to be secured in intermediate positions.

The connecting element can have any desired constructive design. According to a first constructive design, a connecting element in the form of a telescopic mechanism can be provided, wherein the telescoping elements of the telescopic mechanism can be lengthwise telescopable. The length of the connecting element can be progressively adjusted by pushing together or pulling apart the telescoping elements.

As an alternative to the utilization of a telescopic mechanism, a scissor jack mechanism may also be used as the connecting element. In this case, the length of the scissor jack elements of the scissor jack mechanism can be adjustable such that the device carrier can be progressively and freely positioned. The lengthwise adjustability of the scissor jack elements in the direction of the longitudinal axis of the scissor jack mechanism can be achieved due to the respectively chosen angle between the scissor jacks that are connected to one another in an articulated fashion. The length of the scissor jacks itself can not varied in this case. The length change effect can be achieved due to the fact that only part of the scissor jack length contributes to the length of the connecting element in the direction of the longitudinal axis of the scissor jack mechanism at all times, namely in dependence on the angle between the scissor jacks.

A suction head that can be mounted on the vehicle, particularly on a vehicle window, by building up a negative pressure can be particularly suitable for use as the mounting element for mounting the mounting device in the vehicle. Due to this measure, the mounting device can be variably used in different types of vehicles because only a certain clearance surface is required on the vehicle, particularly in the inner region of the windshield, as counterpart for the suction head.

In order to additionally improve the variability for positioning the device carrier, an articulation may be respectively provided between the mounting element and the connecting element and between the device carrier and the connecting element. Such articulations can be pivoted uniaxially as well as multiaxially (spherical head) in order to adjust the angular position of the connecting element relative to the mounting element on one hand and relative to the device carrier on the other hand.

When using a mounting element of symmetric design, particularly point-symmetric design, or a device carrier of symmetric design, particularly point-symmetric design, can be advantageous if the respective articulation between the mounting element and the connecting element on one hand and/or between the device carrier and the connecting element on the other hand can be arranged outside the axis of symmetry or outside the point of symmetry. Due to this measure, the mounting device can be folded up such that it has a very small size and the required stowage space is reduced accordingly.

It can also be particularly advantageous if the device carrier is connected to the connecting element in a detachable and exchangeable fashion. This can make it possible to mount different device carriers on the mounting device by detaching and exchanging the device carrier such that one and the same mounting device ultimately can be used in combination with device carriers that are specifically adapted to certain devices. The device carrier, in particular, may be connected to the articulation in a detachable and exchangeable fashion.

The articulations of the mounting device can be fixable by use of one respective fixing device in order to permanently secure the angles adjusted by the user. Alternatively, the articulations may also be realized in a self-locking fashion in order to preclude unintentional adjustments.

Two embodiments of the invention are schematically illustrated in the figures and described in an exemplary fashion below.

### BRIEF DESCRIPTION OF THE DRAWINGS

FIG. 1 is a side view of a mounting device with a telescopic mechanism in the extended state;

FIG. 2 is the mounting device according to FIG. 1 in the shortened state;

FIG. 3 is a side view of a mounting device with a scissor jack mechanism in the extended state, and

FIG. 4 is the mounting device according to FIG. 3 in the shortened state.

### DETAILED DESCRIPTION OF THE EXAMPLE EMBODIMENTS

FIG. 1 shows a mounting device 01 for fixing a navigation system 02 in the interior 03 of a motor vehicle. A suction head 05 serves for fixing the mounting device 01 on the inner side of the windshield 04 of the motor vehicle, wherein said suction head makes it possible to build up a negative pressure toward the windshield 04. The navigation system 02 is fixed on the mounting device 01 by means of a device carrier 06 that can be attached to a mounting coupler 07 in a detachable and exchangeable fashion.

A connecting element 08 that is composed of four telescoping elements 09 extends between the suction head 05 and the device carrier 06. In this case, the diameter of the successive telescoping elements 09 is reduced step-by-step such that the telescoping elements can be extended and shortened in a telescopic fashion in order to thusly vary the length of the connecting element 08 progressively.

An adaptation of the angular position of the connecting element 08 relative to the suction head 05 and of the angular position of the device carrier 06 relative to the connecting element 08 in dependence on the respective user can be realized with articulations 10 and 11 that are respectively provided between the device carrier 06 and the connecting element 08 on one hand and between the connecting element 08 and the suction head 05 on the other hand.

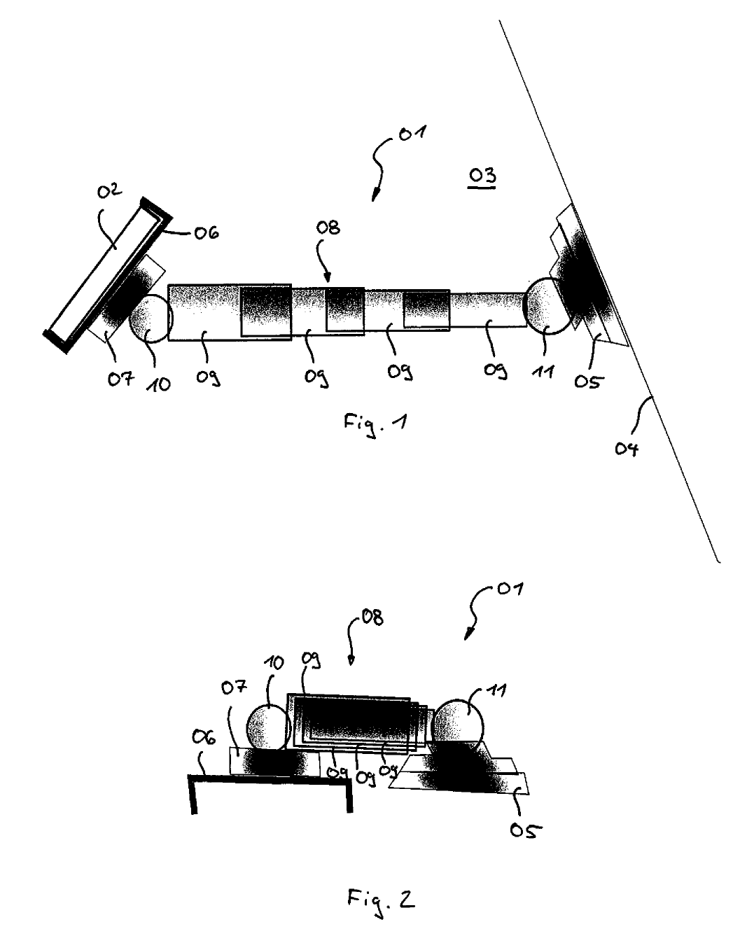

FIG. 2 shows the mounting device 01 after it was detached from the windshield 04 and the navigation system 02 was removed. The connecting element 08 is completely pushed together and the suction head 05 and the device carrier 06 are folded in such that only a very small stowage space is required for stowing the mounting device 01. The articulation 10 is coupled to the mounting coupler 07 eccentrically, i.e., outside the axis of symmetry of the device carrier 06, such that the device carrier 06 can be folded in a space-saving fashion.

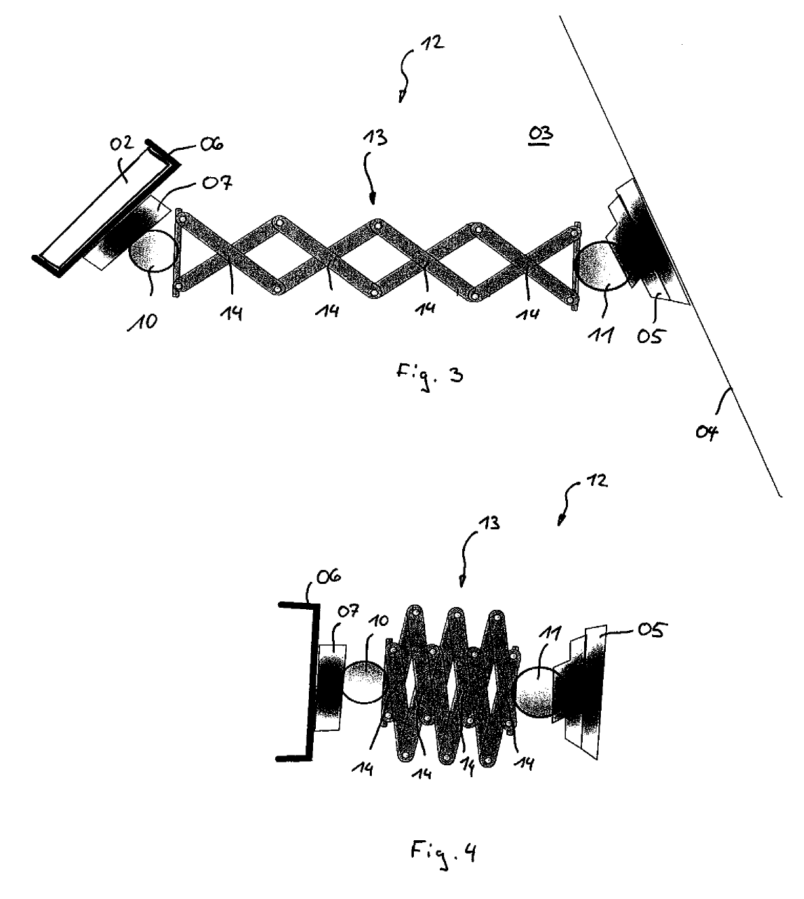

FIG. 3 shows a second embodiment 12 of a mounting device for fixing a navigation system 02 in the interior 03 of a motor vehicle. Analogous to the design of the mounting device 01, the mounting device 12 is also equipped with a suction head 05, a device carrier 06, a mounting coupler 07 and two articulations 10 and 11. The mounting device 12 can be distinguished from the mounting device described above by the constructive design of the connecting element 13 used, wherein said connecting element is realized in the form of a scissor jack mechanism and is composed of four scissor jack elements 14.

FIG. 4 shows the mounting device 12 in the shortened state after it was detached from the windshield 04 and the navigation system 02 was removed.

1. A mounting device for fixing a portable electronic device, particularly a portable navigation system, in the interior of a vehicle, the mounting device comprising:
a mounting element that can be detachably fixed on a component of the vehicle;
a device carrier, on which the electronic device can be detachably fixed; and
a connecting element connecting the mounting element to the device carrier;
wherein the length of the connecting element is adjustable between at least two positions.

2. The mounting device of claim 1, wherein the length of the connecting element is progressively adjustable between two end positions.

3. The mounting device of claim 2, wherein a fixing device or a snap-in device is provided on the connecting element in order to fix the connecting element in at least one end position and/or in at least one intermediate position between the two end positions.

4. The mounting device of claim 2, wherein the connecting element is configured to be self-locking in order to be fixed in the end positions and/or in intermediate positions.

5. The mounting device of claim 1, wherein the connecting element comprises a telescopic mechanism including a plurality of telescoping elements that are lengthwise telescopable.

6. The mounting device of claim 1, wherein the connecting element comprises a scissor jack mechanism including a plurality of scissor jack elements that are lengthwise adjustable.

7. The mounting device of claim 1, wherein the mounting element comprises a suction head that can be mounted on the vehicle, particularly on the windshield, by building up a negative pressure.

8. The mounting device of claim 1, further comprising a uniaxially or multiaxially adjustable articulation provided between the mounting element and the connecting element.

9. The mounting device of claim 8, wherein the mounting element is realized symmetric about an axis of symmetry, particularly point-symmetric about a point of symmetry, wherein the articulation is arranged on the mounting element outside the axis of symmetry or outside the point of symmetry.

10. The mounting device of claim 1, wherein the device carrier is connected to the connecting element in a detachable and exchangeable fashion.

11. The mounting device of claim 1, further comprising a multiaxially adjustable articulation provided between the device carrier and the connecting element, wherein the device carrier is connected to the articulation, in particular, in a detachable and exchangeable fashion.

12. The mounting device of claim 11, wherein the device carrier is realized symmetric about an axis of symmetry, particularly point-symmetric about a point of symmetry, wherein the articulation is arranged on the device carrier outside the axis of symmetry or outside the point of symmetry.

13. The mounting device of claim 11, wherein the articulation can be fixed by means of a fixing device or is realized in a self-locking fashion.
